(19) United States
(12) Patent Application Publication
(10) Pub. No.: US 2002/0018075 A1
(43) Pub. Date: Feb. 14, 2002

(54) Computer-based educational system

(76) Inventors: Sunil Maulik, Santa Clara, CA (US); Salil D. Patel, Cupertino, CA (US)

Correspondence Address: James R. Abney, KOLISCH, HARTWELL, DICKINSON, McCORMACK & HEUSER, 520 S.W. Yamhill Street, Suite 200, Portland, OR, 97204, US

(21) Appl. No.: 09/843,163

(22) Filed: Apr. 25, 2001

Related U.S. Application Data
(60) Provisional application No. 60/199,607, filed on Apr. 25, 2000.
(60) Provisional application No. 60/233,509, filed on Sep. 19, 2000.

(51) Int. Cl. G06F 3/00

(52) U.S. Cl. 345/732

(57) ABSTRACT

A computer-based educational system and method for presenting information. The system may include among others a content pane configured to present a presentation of a series of slides, and a progress control configured to adjust a user's progress through a currently displayed slide, a progress indicator configured to indicate a user's time-based viewing progress through a slide, a presentation, or a series of presentations, and/or a link to a text transcript of any associated voiceover narration.

### CROSS REFERENCE TO RELATED APPLICATIONS

This application is based upon and claims priority under 35 U.S.C. § 119(e) to the following U.S. provisional patent applications, each of which is incorporated herein in its entirety for all purposes: Ser. No. 60/199,607, entitled “Information Transfer System,”filed Apr. 25, 2000; and Ser. No. 60/233,509, entitled “Information Transfer System,”filed Sep. 19, 2000.

### FIELD OF THE INVENTION

The invention relates to a computer-based educational system and method for presenting information.

### BACKGROUND OF THE INVENTION

Information may be defined as a collection of facts or data, which typically relate to some object or event. Information may be derived in various ways, including study, experience, and/or instruction. For example, information may be derived from a presentation in which a speaker shows and comments upon slides, overhead transparencies, and/or other visual aids.

Presentations are perhaps the most common mode of organized instruction and form the foundation of our educational system. Yet, standard presentations suffer from a number of shortcomings. For example, the form and pacing of presentations are dictated largely by the presenter. Thus, viewers have little or no opportunity to start and stop the presentation (except through disruptive question asking) for reflection, note taking, or related study. Viewers also have little or no opportunity to repeat the presentation, or particularly to repeat portions (especially difficult portions) of the presentation before proceeding to subsequent portions.

Mechanisms for preparing and/or delivering presentations also suffer from a number of shortcomings. Traditionally, presentations have been prepared and then delivered to viewers using tools directed to each individual step in the process. For example, content may be created and converted into slides or overhead transparencies, which then must be presented using a slide projector or overhead projector, respectively, limiting flexibility.

Recently, computer-based presentation tools such as Microsoft PowerPoint have been developed that assist with both preparation and presentation; however, these tools also suffer from a number of shortcomings. For example, a user may mishear narration or become confused when listening to narration of complex topics. Using present computer-based presentation tools, the user is forced to replay the entire narration, which wastes the time of a user who desires only to listen to a particular passage. In addition, a user may lose track of his progress through a presentation. In particular, present tools do not provide a user with any estimate of the approximate time it will take to complete a particular slide of the presentation, or the presentation as a whole. Moreover, present tools cannot be used easily by users in remote locations using computer networks such as the Internet. Finally, present tools have user interfaces that are difficult to understand and that may hinder the user's mastery of a subject.

Thus, there is a need for an improved computer-based educational system and method for presenting information.

### SUMMARY OF THE INVENTION

The invention provides a computer-based educational system and method for presenting information. According to one aspect, the invention may include a system having a content pane configured to present a presentation of a series of slides, and a progress control configured to adjust a user's progress through a currently displayed slide. According to another aspect, the invention may include a system having a content pane configured to present a presentation of a series of slides, and a progress indicator configured to indicate a user's time-based viewing progress through the presentation. According to still another aspect, the invention may include a system having a content pane configured to present a series of slides, the slides being accompanied by voiceover narration, and a link to a text transcript of the voiceover narration. According to still another aspect, the invention may include methods for using a computer-based educational system, including methods for using a content pane, progress control, progress indicator, and/or transcript of a voiceover narration.

### BRIEF DESCRIPTION OF THE DRAWINGS

FIG. 1 is a schematic view of a computer-based educational system in accordance with one embodiment of the invention.

FIG. 2 is a schematic view of a computing device suitable for use as a client, course development and hosting system, and/or content source of the system of FIG. 1.

FIG. 3 is a schematic view of software and hardware elements involved in creation of a presentation using the educational system of FIG. 1.

FIG. 4 is a schematic view of software and hardware elements involved in presenting a presentation using the educational system of FIG. 1.

FIG. 5 is a presentation window of a graphical user interface of a viewing engine on the client of FIG. 1.

FIG. 6 is the graphical user interface shown in FIG. 5, further showing a resources window and a help window.

FIG. 7 is the graphical user interface shown in FIG. 5, further showing a transcript window and a glossary window.

### DETAILED DESCRIPTION OF THE INVENTION

The invention provides a computer-based educational system and method for presenting information.

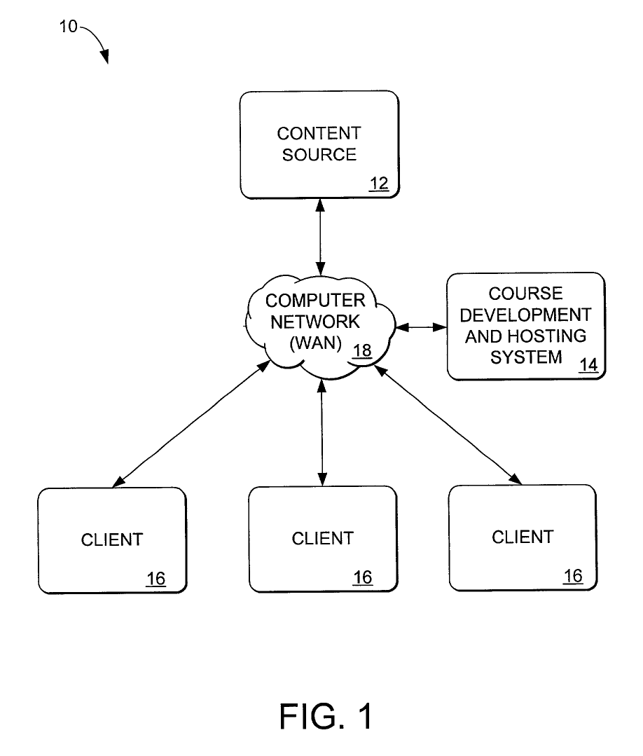

FIG. 1 shows an educational system 10 according to one embodiment of the invention. Educational system 10 typically includes a content source 12, a course development and hosting system 14, and a plurality of clients 16, linked by a computer network 18. As described in detail below, native content from content source 12 is formed into a computer-based presentation and served to clients 16 by course development and hosting system 14.

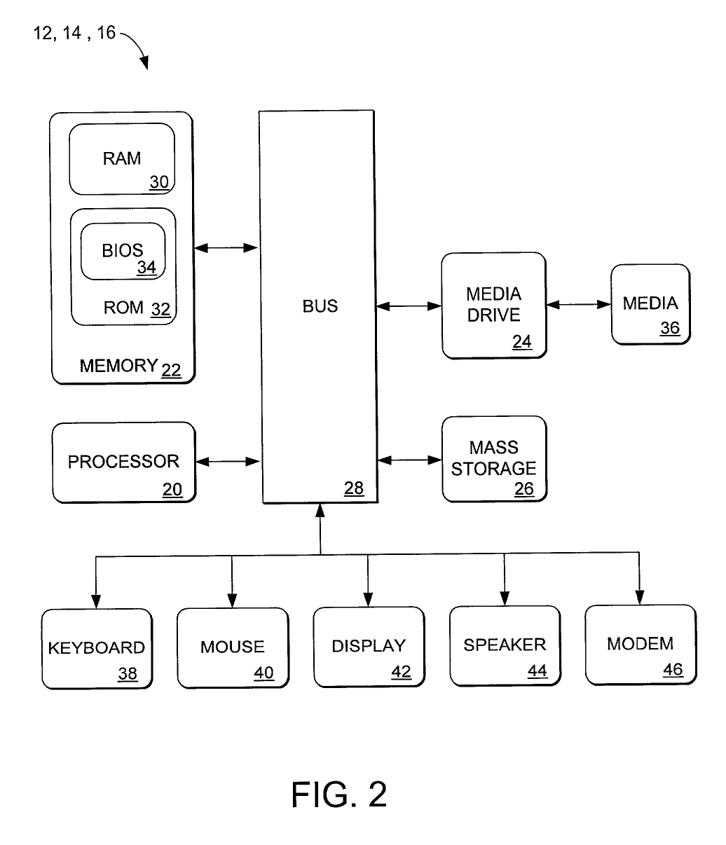

FIG. 2 illustrates an exemplary computing device suitable for use as content source 12, course development and hosting system 14, and/or client 16. For simplicity, the exemplary computing device of FIG. 2 will be described hereafter with reference to client 16 only.

Client 16 typically includes a processor 20 linked to a memory 22, a media drive 24, and a mass storage device 26 via a bus 28. Memory 22 typically includes random access memory (RAM) 30 and read only memory (ROM) 32. ROM 32 typically includes a Basic Input Output System (BIOS) 34 including basic routines configured to start-up and operate client 16. Media drive 24 typically is a DVD ROM drive, CD ROM drive, floppy disk drive, magneto optical drive, or other drive configured to read media 36 such as a DVD ROM, CD ROM, floppy disk, or magneto-optical disk. Mass storage device 26 typically is a hard drive. Processor 20 is configured to execute programs stored on mass storage device 26 or media 36 using portions of memory 22.

Client 16 further may include additional components. For example, client 16 may include user input devices, such as a keyboard 38 and mouse 40, as well as a display 42 and speaker 44. Client 16 also may include a network interface such as a modem 46, which enables the client to communicate via computer network 18.

Course development and hosting system 14 may include one or more computing devices of the type shown in FIG. 2. For example, as described below, course development and hosting system 14 typically includes a host server configured to run a server application, and a course development device configured to run a course development engine. Typically, the host server and the course development device are separate computing devices of the type shown in FIG. 2. Alternatively, the course development engine and server application may be executed by a single computing device or by multiple distributed computing devices.

Computer network 18 typically is a Wide Area Network (WAN), such as the Internet. Alternatively, educational system 10 may be implemented entirely within a Local Area Network (LAN), via a private wide area network such as a Virtual Private Network (VPN), or via another suitable computer network.

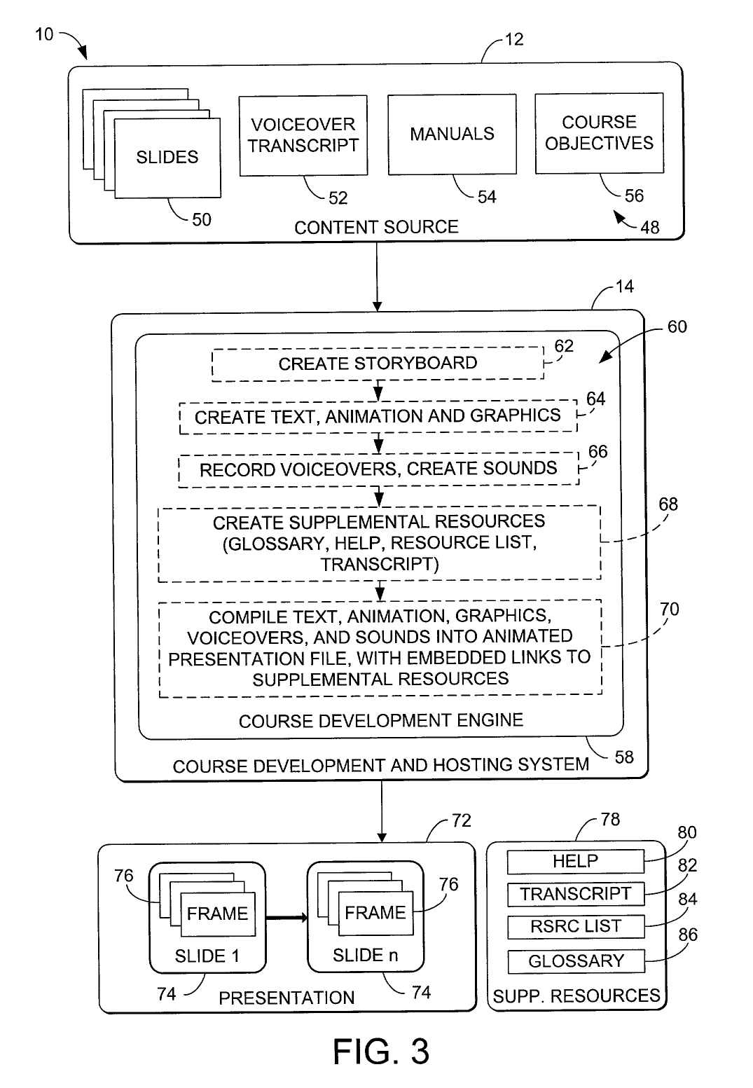

As shown in FIG. 3, content source 12 typically includes native content 48 including slides 50, voiceover transcript 52, manuals 54, and/or course objectives 56. As used herein, the term “native content” refers to content in an original, unmodified form, as provided by content source 12. Slides 50 typically are generated using Microsoft PowerPoint software, and may include text and/or graphics. Alternatively, overhead projector, 35 mm, or other slides may be used. Voiceover transcript 52 and manuals 54 typically are submitted as print and/or electronic documents. Course objectives 56 include the content provider's objectives for the course, including the desired level of subject matter mastery, look and feel of the course, and other desired course parameters. In addition, native content 48 may include a variety of other materials, such as background reading materials, hypertext links to related resources, bibliographies, advertising links, etc.

Native content 48 is sent from content source 12 to a course development engine 58 on course development and hosting system 14, typically via network 18, although a CD ROM or other storage media may be used for transfer. Course development engine 58 typically is configured to “re-purpose” or transform the native content 58 into a presentation 72, and thus also may be referred to as a re-purposing engine.

Course development engine 58 typically is configured to enable a user to practice the method 60 shown at steps 62-70.

At 62, the method typically includes creating a storyboard based on slides 50, voiceover transcript 52, manuals 54, course objectives 56, and other native content 48 provided by the content source 12. To create a storyboard, course parameters such as plot, action, and/or characters are developed and laid out as a series of sequential scenes. Storyboarding may involve selecting the number of slides and the number of associated graphics and animations, among others. The starting point for storyboarding may be materials from a conventional presentation, such as slides 50 and associated voiceover text 52 and URLs. Transitions between slides (commonly called “splash screens”) also may be specified during storyboarding.

At 64, the method includes creating primary visual resources such as text, animation, and graphics (including still and video images) for presentation 72. As used herein, the term “primary resources” refers to resources used within presentation 72 itself. The term “supplemental resources” is used to refer to resources that are linked to presentation 72, but which are not contained within presentation 72 itself. The term “presentation” refers to a series of slides or other modules that present information on a particular topic or set of topics, as discussed below.

Presentation 72 may be used as part or all of a computer-based course or certification program, for example, to demonstrate mastery of a subject area or competency to run a particular piece of equipment or perform a particular assay. If used as part of a course or certification program, the presentation may be combined with outside presentation materials, including lectures, demonstrations, discussions, and/or other presentations. These outside materials may be in various forms, including live or prerecorded, in-person or on-line, etc. Presentation 72 also may be combined with testing materials, including term papers, quizzes, and/or final examinations. These testing materials may be executed on-line and/or on-paper. For example, quizzes may be taken interactively through a web site, or downloaded and printed from a web site or e-mail communication.

At 66, the method includes creating primary audio resources by recording voiceover narration and generating other sounds for presentation 72. The script for the voiceover narration recordings may be based on transcript 52 provided by the content source. Alternatively, the content source may request that a script be developed using the course development engine, after storyboarding and generation of slide text, graphics, and animation has occurred. Primary audio and visual resources for the presentation typically are gathered from the content source or generated/selected using specialized audio and visual helper applications (e.g., Photoshop) associated with the course development engine.

At 68, the method further includes creating supplemental resources 78 used by presentation 72, including a help file 80, transcript 82, resources list 84, and/or glossary 86, among others. These supplemental resources are further described below.

At 70, the method includes compiling primary visual resources, such as text, animation, and graphics, and primary audio resources, such as voiceovers and sounds, into an animated presentation 72 with embedded hypertext links to supplemental resources 78. The presentation also may include a variety of other links, including links to pop-up windows that include detailed information on a particular topic, content index links, etc.

Typically, the animated presentation is stored in a file format readable by a world wide web browser, such as the Microsoft Internet Explorer browser, available from Microsoft Corporation of Redmond, Wash., or the Netscape Navigator browser, available from Netscape Communications Corporation of Santa Clara, Calif. Typically, the animated presentation file is read using a plug-in software module associated with the animation file format. One typical example of a suitable animation file format for presentation 72 is the shockwave file format used by the Flash player, available from Macromedia, Inc. of San Francisco, Calif. The invention also may make use of streaming audio and video technologies to deliver presentation 72 to client 16.

Completed presentation 72 typically includes a plurality of slides 74. Each slide 74 typically includes one or more frames 76. Slides with complex animations may include a large number of frames. Slides 74 may include various textual, graphical, and/or animated elements, as well as voiceover narration and sounds, as described above. Accompanying the completed presentation 72 are various supplemental resources 78, including help file 80, transcript 82, resources list 84, and/or glossary 86, produced at step 68.

Information in presentations according to the invention typically is selected based on the purpose of the presentation. This purpose may be substantially academic, for example, to educate on topics such as “drug discovery,” “molecular diagnostics,”“molecular biology,” “gene chips,” and/or “drug design,” among others. This purpose also may be substantially commercial, for example, to educate a potential buyer about attributes or advantages of a product or to educate an actual buyer about how to use a product. There generally is no limit on the purpose or content of a presentation, although preferred content relates to biology, and especially to molecular biology and genomics.

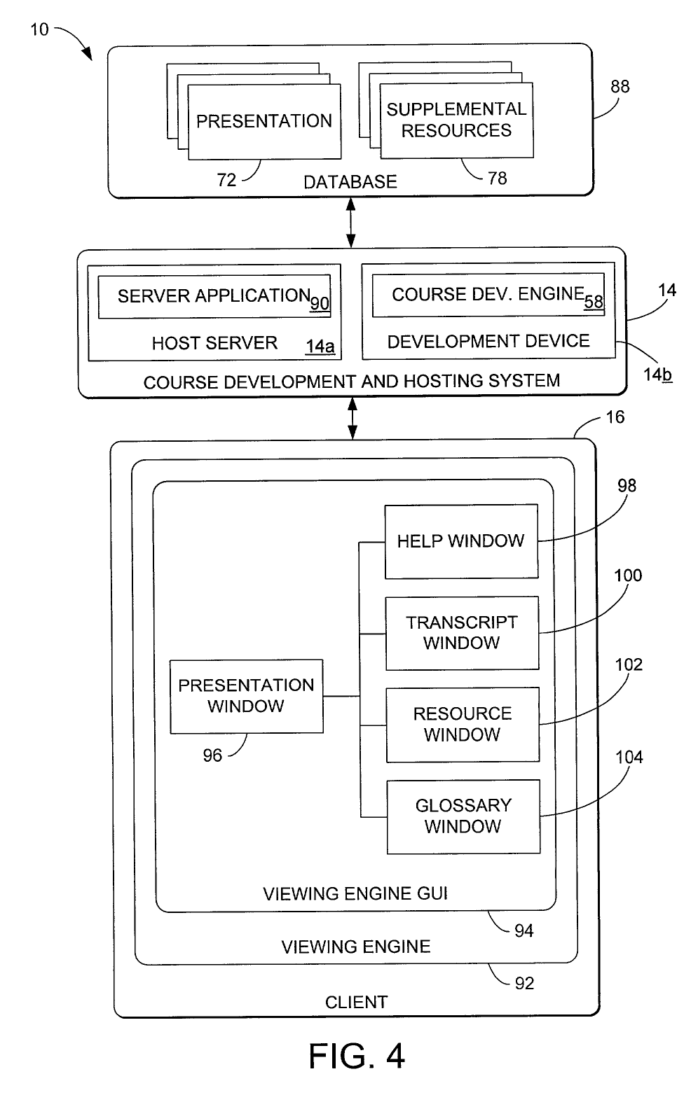

As shown in FIG. 4, one or more presentations 72 and associated supplemental resources 78 typically are stored in a database 88 accessible by course development and hosting system 14. Course development and hosting system 14 typically includes host server 14a configured to execute a server application 90, and course development device 14b configured to execute course development engine 58. Typically, server application 90 is configured to retrieve presentation 72 and associated supplemental resources 78 from database 88 and serve them to a requesting client 16. Typically, data for presentation 72 and supplemental resources 78 is served in the form of static and dynamic HTML (web) pages according to the HyperText Transfer Protocol (HTTP).

Client 16 typically includes a viewing engine 92 having a viewing engine graphical user interface (GUI) 94. Viewing engine 92 may be implemented on a browser such as Microsoft Internet Explorer or Netscape Navigator, described above. Viewing engine GUI 94 typically includes a presentation window 96 configured to present audiovisual presentation 72. Viewing engine GUI 94 also may include windows configured to display supplemental resources 78, including a help window 98, transcript window 100, resources window 102, and/or glossary window 104, respectively configured to display help file 80, transcript 82, resources list 84, and glossary 86.

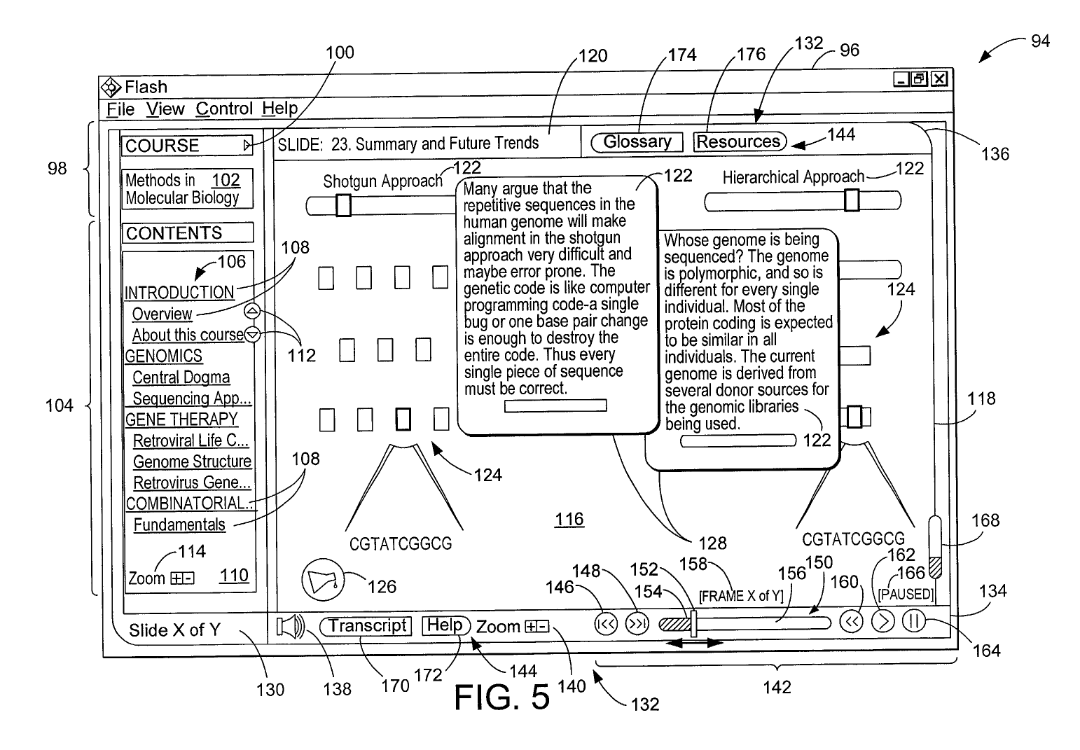

As shown in FIG. 5, presentation window 96 typically includes a course selector 98 configured to enable a user to select a course presentation for study. Course selector 98 typically includes a pull down menu selector 100 from which a desired course may be selected, and a course title pane 102 in which the title of the selected course is displayed. Once the desired course is selected, a presentation 72 associated with the selected course is downloaded to the viewing engine from host server 14a.

Presentation window 96 also typically includes a topic selector 104, also referred to as a table of contents selector 104. Table of contents selector 104 typically includes a list or index 106 of hyperlinked topics 108 contained within a table of contents pane 110. Topic list 106 typically is scrollable via scroll controls 112. Table of contents pane 110 also may be zoomable via zoom controls 114.

Presentation window 96 also typically includes a content pane 118 or slide pane 118 configured to display slides 116 of the presentation. Upon user selection of a hyperlinked topic 108, viewing engine GUI 94 is configured to present within content pane 118 a displayed slide 116 related to the selected topic. As used herein, reference designator 116 will be used to refer to a displayed slide 116, while reference designator 74 will be used to refer to a stored slide in presentation 72. However, 116 and 74 generally identify the same slide. Typically, each hyperlink 108 is associated with one slide, and a single click (with a mouse or other pointing device) of the hyperlink leads a user to the first frame of the associated slide. Alternatively, one hyperlink may be associated with a plurality of slides. As another alternative, several hyperlinks may lead to different frames within a single slide.

Presentation window 96 also typically includes a slide title pane 120 configured to display a title of the displayed slide 116. A subtitle also may be displayed within slide title pane 120.

Displayed slide 116 typically includes a variety of audiovisual content, including text 122, graphics 124, animations, sounds, and/or voiceover audio. The appearance of displayed slide 116 typically changes as frames 76 are cycled through by GUI 94. Slide 116 also may include a pop-up window selector 126, shown in the shape of an Erlenmeyer Flask. Upon selection of the pop-up window selector 126, GUI 94 is configured to display one or more pop-up windows 128 containing detailed information related to slide 116. The detailed information may include text 122, graphics, animations, sounds, alternate voiceover audio, and/or virtually any other suitable content.

Contextual information also may be presented in content pane 118 to put presentation 72 in context. For example, information relating to course providers, course promoters (e.g., advertisements), and related courses may be included in pane 118. Typically, this information is included at the beginning or end of presentation 72. Alternatively, it may be provided in a dedicated region of pane 118.

Presentation window 96 also typically includes a slide indicator 130 configured to indicate the number of the current slide and the number of total slides in the presentation, typically in the form “Slide X of Y.”

Presentation window 96 also typically includes a variety of presentation controls 132. Controls 132 typically are laid out in a lower control bar 134 positioned below content pane 118 and an upper control bar 136 positioned above content pane 118, although numerous possible alternative layouts also are possible. Controls 136 typically include an audio control 138, zoom control 140, slide navigation controls 142, and supplemental resource selectors 144. Supplemental resource selectors 144 may be positioned both in the lower control bar 134 and in the upper control bar 136, and are discussed further below.

Audio control 138 typically presents a user, upon selection, with a pop-up tool with which the volume of the presentation audio may be adjusted. Typically, the volume control adjusts the overall volume of the presentation, such that the respective volumes of the embedded sounds, voiceover audio, and other audio types are adjusted at once. Alternatively, the volume control may include independent selectors configured to adjust independently the volume of various sounds, voiceover audio, and other audio within the presentation.

Zoom control 140 typically includes zoom in and zoom out selectors. As the user actuates the zoom in and zoom out selectors, the presentation window is configured to alter the scale of displayed slide 116 within pane 118.

Navigation controls 142 typically include a next slide selector 146 and a previous slide selector 148, which, upon selection, cause the next and previous slides in the presentation to be displayed in content pane 118, respectively. Navigation controls 142 further may include a progress control 150, typically formed in the shape of a slider with a handle 152. Progress control 150 typically is configured to alter the user's progress within the current slide. As the user slides handle 152 back and forth, region 154 is shaded, while region 156 appears blank, thereby indicating to the user the position of the current frame relative to prior frames and remaining frames. Alternatively, region 154 and region 156 may be colored, shaded, and/or patterned in another manner to make them distinguishable from each other. As the user moves handle 152 back and forth, pop-up frame indicator 158 appears and indicates, in real-time, the current frame, typically in the form “Frame X of Y.” When the user releases handle 152, pop-up frame indicator 158 typically disappears. In addition, the frame of slide 116 is updated in content pane 118 while the user is adjusting handle 152, so that the user can view the content of the various frames while the user is scrolling.

Navigation controls 142 also typically include a rewind control 160 configured to rewind to the first frame of the current slide. Navigation controls 142 also include a play control 162 and a pause control 164, by which the user can alternately play and pause the currently displayed slide. Typically, a pop-up pause indicator 166 appears when the pause control has been selected by the user, and disappears when the user selects play control 162 or otherwise causes the presentation to continue. Pause indicator 166 is particularly useful to users of system 10 on networks that are congested, because these users can easily tell if a presentation is paused intentionally, or if the presentation is stalled due to network congestion.

Presentation window 96 also typically includes a progress indicator 168, configured to indicate a user's progress through the current slide. The progress indicator typically includes distinguishably colored, shaded, and/or patterned portions, similar to control 150, such that a user may quickly and visually detect the user's progress through an individual slide of the presentation. Alternatively, progress indicator 168 (and progress control 150) may be configured to indicate a user's progress through an entire presentation, a subset of slides within a presentation, or a plurality of presentations.

Typically, progress control 150 and progress indicator 168 are operatively linked, such that the progress adjusted by progress control 150 is immediately and directly reflected in progress indicator 168. Typically, progress control 150 and progress indicator 168 are configured to indicate a frame-based progress through a slide or presentation. Absent network congestion, the frames of the presentation are presented in real-time. Thus, progress control 150 and progress indicator 168 may be said to be time-based, because each controls and/or indicates the time that has passed and the time that is remaining in a slide or presentation, via regions 154 and 156, respectively.

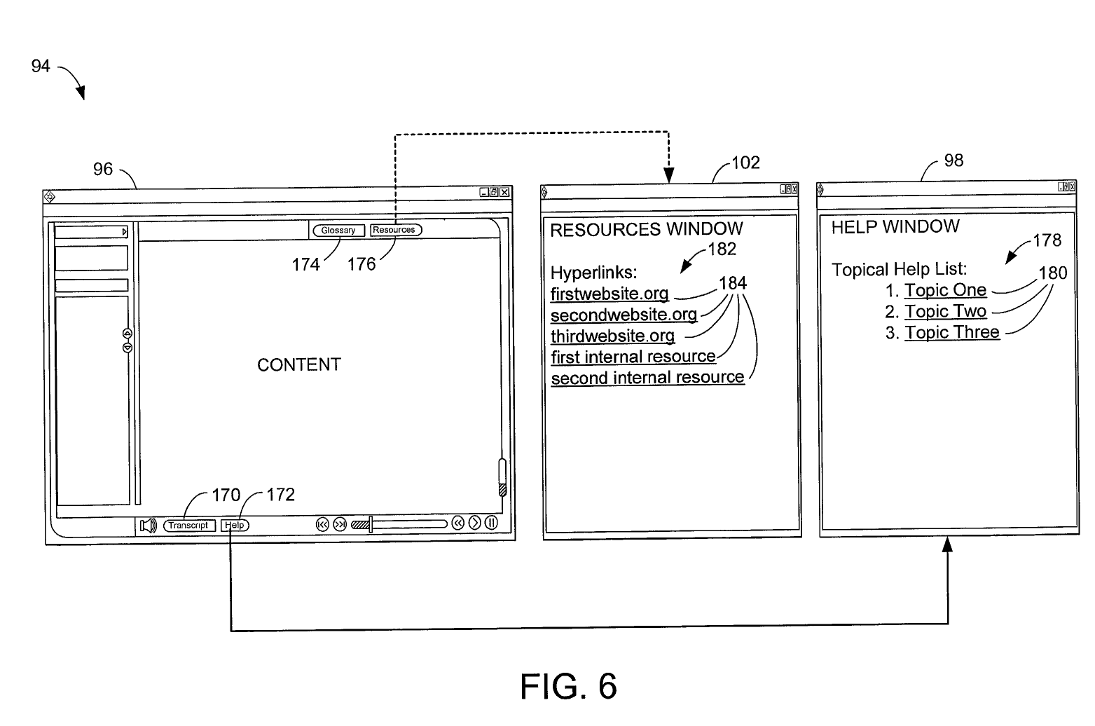

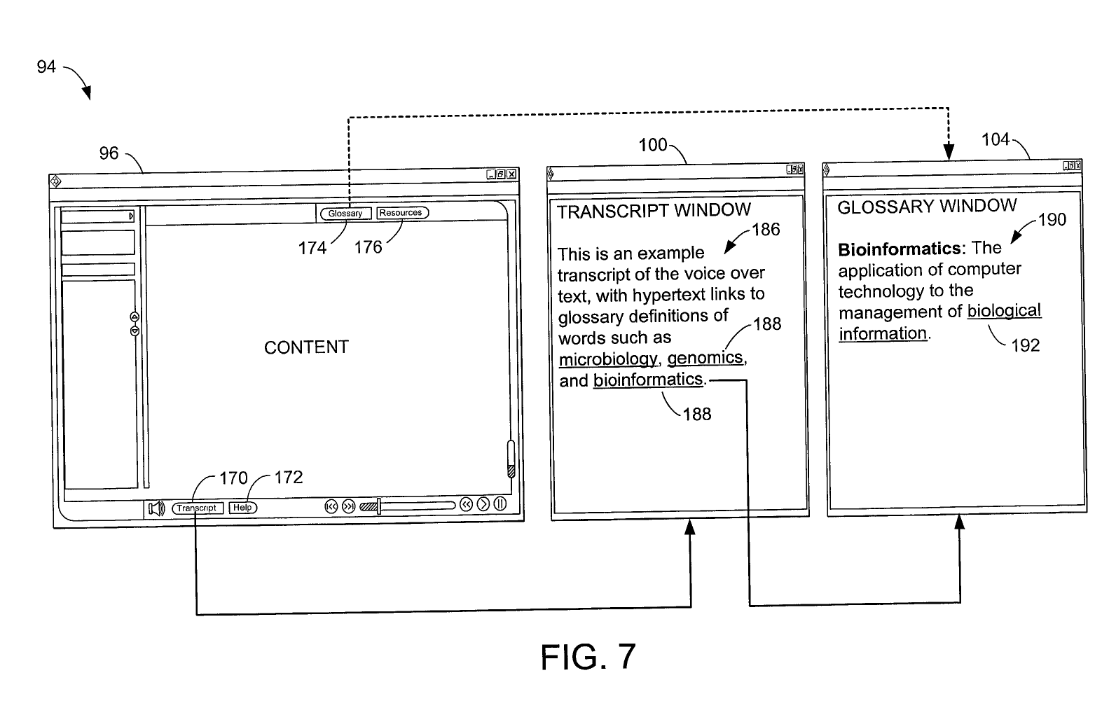

Supplemental resource selectors 144 typically include transcript selector 170 and help selector 172 positioned in lower control bar 134, and glossary selector 174 and resources selector 176 positioned in upper control bar 136. As shown in FIG. 6, selection of help selector 172 causes help window 98 to appear, and selection of resources selector 176 causes resources window 102 to appear. As shown in FIG. 7, selection of transcript selector 170 causes transcript window 100 to appear, and selection of glossary selector 174 causes glossary window 104 to appear.

Help window 98 typically includes a topical help list 178 of hyperlinks 180 to detailed help information. Upon selection of one of hyperlinks 180, detailed information typically appears in help window 98, or alternatively may appear in a separate window.

Resources window 102 typically includes a resources list 182. Resources list 182 typically includes hyperlinks 184 to internal resources and/or external resources. Internal resources are so termed because they typically are stored as supplemental resources on database 88 and served by course development and hosting system 14. External resources are so termed because they are served by external servers connected to network 18. The internal and external resources listed in resources list 182 may include virtually any suitable material related to the subject matter of the presentation. For example, links to studies, journal articles, primers, and/or other explanatory materials may be provided.

Transcript window 100 typically includes an at least substantially word-for-word text transcript 186 of the voiceover audio accompanying presentation 72. In some embodiments, the transcript may be reworded, abbreviated, augmented, and/or translated (e.g., into a foreign language), as desired, as long as it still tracks the presentation. Text transcript 186 typically includes hyperlinks 188 to glossary definitions of certain words used in the transcript.

Glossary window 104 typically presents via viewing engine 92 a glossary definition of words selected by a user using hyperlink 188. The glossary definition 190 also may contain hyperlinks 192 to definitions of other words. When accessed from a hyperlinked word such as shown at 188, the glossary window typically opens directly to the definition of the word, as shown. However, when accessed from glossary selector 174, the glossary window typically displays a listing of glossary contents.

Glossary contents may be arranged in various ways. For example, glossary contents may be divided by importance into “essential terms” and optional “advanced-terms.”Within these areas, glossary contents may be arranged alphabetically and/or by subject matter to facilitate access. Essential terms may be repeated within an advanced-terms listing, so that essential terms presents the most important terms and advanced terms presents all of the defined terms.

In some embodiments, the slides, transcript, and/or glossary may be provided in hard copy form to augment the computer-based presentation. For example, the glossary may be provided as a standalone book containing a listing such as an alphabetical listing of glossary terms and corresponding definitions.

The above described system may be used to practice methods according to the invention. One exemplary method according to the invention includes displaying a presentation of a series of slides in a content pane, and indicating a user's time-based viewing progress through the presentation via a progress indicator. Another exemplary method according to the invention includes displaying a presentation of a series of slides in a content pane, the slides being accompanied by voiceover narration, and providing a user-selectable link to a text transcript of the voiceover narration. Still another exemplary method according to the invention includes displaying a presentation of a series of slides in a content pane, the slides having accompanying voiceover narration, providing a user-selectable link to a text transcript of the voiceover narration, and indicating a user's time-based viewing progress through the presentation via a progress indicator.

The various embodiments of the above-described computer-based educational system and method enable users to quickly and easily access information in presentations on a virtually limitless variety of topics. The embodiments of the invention enable users to easily gauge their progress through a particular slide or through the presentation as a whole, and provide users one click access to supplemental resources such as transcripts, resources, help, and a glossary. These features and the many other features of the embodiments of the invention described above result in an improved learning experience for users.

While the invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

1. A computer-based educational system, comprising:
a content pane configured to present a presentation of a series of slides; and
a progress control configured to adjust a user's progress through a currently displayed slide.

2. The system of claim 1, wherein the currently displayed slide includes a plurality of frames, and the progress control is configured to adjust the currently displayed frame of the currently displayed slide.

3. The system of claim 2, wherein the progress control is configured to enable the user to sequentially scroll through the frames of the slide, and wherein the content pane is configured to display the frames in real-time as the user scrolls.

4. The system of claim 1, wherein the progress control includes slider having a handle.

5. The system of claim 2, wherein the progress control further includes distinguishable regions indicating a previously viewed portion of the currently displayed slide and a remaining portion of the currently displayed slide.

6. The system of claim 1, further comprising navigation controls selected from the group consisting of next slide control, previous slide control, rewind slide control, play control, and pause control.

7. The system of claim 1, wherein the progress control is configured to indicate a user's time-based viewing progress through the currently displayed slide.

8. The system of claim 1, further comprising a progress indicator independent from and operatively linked to the progress control, such that progress adjustments made via the progress control are directly reflected in the progress indicator.

9. The system of claim 1, further comprising a table of contents pane including hyperlinks to the slides of the presentation.

10. The system of claim 1, further comprising a slide title pane configured to display a title of the currently displayed slide.

11. The system of claim 1, further comprising a volume control configured to control the volume of the presentation displayed in the content pane.

12. The system of claim 1, further comprising a pop-up window selector configured to display a pop-up window containing detailed information related to the currently displayed slide.

13. The system of claim 1, wherein the presentation includes voiceover narration, the system further comprising, a transcript selector configured to cause a text transcript of the voiceover narration to be displayed.

14. The system of claim 1, further comprising, a help selector configured to 10 cause a help file related to the presentation to be displayed.

15. The system of claim 1, further comprising, a glossary selector configured to cause a glossary related to the presentation to be displayed.

16. The system of claim 1, further comprising, a resources selector configured to cause a resources list related to the presentation to be displayed.

17. The system of claim 1, further comprising, a slide indicator configured to indicate the number of the current slide and the number of total slides in the presentation.

18. The system of claim 1, further comprising, a course selector configured to enable a user to choose a presentation to be viewed in the content pane.

19. A computer-based educational system, comprising:
a content pane configured to present a presentation of a series of slides; and
a progress indicator configured to indicate a user's time-based viewing progress through the presentation.

20. A computer-based educational system, comprising:
a content pane configured to present a series of slides, the slides being accompanied by voiceover narration; and
a link to a text transcript of the voiceover narration.

21. A computer-based educational system, comprising:
a content pane configured to present a presentation of a series of slides, each slide consisting of one or more frames, the presentation including voiceover narration;
a progress control configured to adjust a user's progress through a currently displayed slide, by adjusting the currently displayed frame of the currently displayed slide, and wherein the content pane is configured to display the frames in real-time as the user scrolls;
a transcript selector configured to cause a text transcript of the voiceover narration to be displayed;
one or more navigation controls selected from the group consisting of next slide control, previous slide control, rewind slide control, play control, and pause control;
wherein the progress control includes slider having a handle, and distinguishable regions indicating a previously viewed portion of the currently displayed slide and a remaining portion of the currently displayed slide.

22. A computer-based educational method, comprising:
displaying a presentation of a series of slides in a content pane; and
indicating a user's time-based viewing progress through the presentation via a progress indicator.

23. A computer-based educational method, comprising:
displaying a presentation of a series of slides in a content pane, the slides being accompanied by voiceover narration; and
providing a user-selectable link to a text transcript of the voiceover narration.

24. A computer-based educational method, comprising:
displaying a presentation of a series of slides in a content pane, the slides having accompanying voiceover narration;
providing a user-selectable link to a text transcript of the voiceover narration; and
indicating a user's time-based viewing progress through the presentation via a progress indicator.
